(19) United States
(12) Patent Application Publication
(10) Pub. No.: US 2026/0264912 A1
(43) Pub. Date: Sep. 10, 2026

(54) Method, system, automated dispensing device and computer program product for determining compliance of medicament packages

(71) Applicant: VMI Holland B.V., Epe (NL)

(72) Inventors: Patrick van Voorn, Epe (NL); Rogier Scheide, Epe (NL)

(73) Assignee: VMI Holland B.V., Epe (NL)

(21) Appl. No.: 18/876,199

(22) PCT Filed: Aug. 3, 2023
(86) PCT No.: PCT/EP2023/071572

§ 371 Date: Dec. 18, 2024

(30) Foreign Application Priority Data
Aug. 4, 2022 (NL) 2032684

(51) Int. Cl. B65B 57/18; A61J 1/03; B65B 9/08

(52) U.S. Cl. CPC B65B 57/18; B65B 5/103; B65B 9/08; A61J 1/03; B65B 57/00; B65B 61/025

(57) ABSTRACT

The invention relates to a method, a system, an automated dispensing device and a computer program product for determining compliance of a plurality of medicament packages for containing discrete medicaments dispensed and packaged by said automated dispensing device, wherein the method comprises the steps of:
for each medicament package of the plurality of medicament packages, associating with the respective medicament package one or more process values indicative of a production process of 41 the automated dispensing device affecting at least one of the respective medicament packages or the discrete medicaments contained in said respective medicament package;
identifying irregularities in the one or more process values; and
recommending at least one medicament package of the plurality of medicament packages for further compliance inspection based on an identified irregularity in the one or more process values associated with said at least one medicament package.

### BACKGROUND

The disclosure relates to a method, a system, an automated dispensing device and a computer program product for determining compliance of medicament packages, in particular pouches.

US 2014/0366489 A1 discloses a device for automatically dispensing solid substances for medical use. The device is provided with a great number of feeder units, also known as ‘canisters’, distributed in a radial grid about a rotation axis. Each feeder unit holds an amount of solid substances specific to that respective feeder unit. Hence, together, the feeder units can dispense a wide variety of solid substances.

The device is further provided with a collection frame that is rotatable about the rotation axis below the array of feeder positions. The collection frame is provided with series of collection trays for collecting solid substances dispensed from any of the feeder units in the array of feeder positions.

The device further comprises a packing unit arranged in a stationary position below the collection frame for packing the solid substances received from the collection trays in a foil that is sealed to form individually closed pockets, also known as ‘pouches’. The collection frame is rotated about the rotation axis such that each collection tray passes along each of the feeder units in the array of feeder positions before arriving at the packing unit.

### SUMMARY OF THE INVENTION

The dispensing device disclosed in US 2014/0366489 A1 is configured for producing the pouches continuously at high speed as part of a string of pouches that remains interconnected when exiting the dispensing device. Each completed pouch is the result of many different steps in the dispensing device, including but not limited to: filling of the feeder units, singulating the discrete medicaments in the feeder units, dispensing the discrete medicaments one-by-one from the feeder units, collecting the discrete medicaments dispensed from the feeder units, rotating the collection frame with the collection trays to the correct feeder positions, printing of relevant information on the foil, sealing and perforating the foil to form the pouches, and discharging the string of pouches from the dispensing device. Outside of the dispensing device, the string of pouches is wound on a collection reel. At a separate inspection station, the string of pouches is unwound again and each pouch is automatically visually inspected by a camera for compliance of the package and the contents of the pouch. If a pouch is found to be non-compliant, a human operator is alerted to manually inspect the non-compliant pouch. Pouches that pass the visual inspection by the camera are processed and sent directly to patients without further human operator intervention.

The visual inspection by the camera is not perfect and it can miss small or partial defects, such as a leaking seal. Consequently, it is possible that pouches which are marked as compliant are actually non-compliant and end up with patients.

It is an object of the present invention to provide a method, a system, an automated dispensing device and/or a computer program product for determining compliance of medicament packages, wherein the compliance determination can be improved.

According to a first aspect, the invention provides a method for determining compliance of a plurality of medicament packages for containing discrete medicaments dispensed and packaged by an automated dispensing device, wherein the method comprises the steps of:
for each medicament package of the plurality of medicament packages, associating with the respective medicament package one or more process values indicative of a production process of the automated dispensing device affecting at least one of the respective medicament packages or the discrete medicaments contained in said respective medicament package;
identifying irregularities in the one or more process values; and
recommending at least one medicament package of the plurality of medicament packages for further compliance inspection based on an identified irregularity in the one or more process values associated with said at least one medicament package.

Irregularities in the one or more process values can be an indication of problems during the production process of the automated dispensing device that may cause defects in the discrete medicaments and/or the medicament package. Some of these defects may be very small or hidden from plain view and therefore potentially difficult to detect during an automatic visual inspection downstream of the dispensing device. Hence, by identifying such irregularities, medicament packages can be recommended or flagged for further compliance inspection, even when the automatic visual inspection does not find any non-compliance. In this manner, defects can be detected more reliably and/or a greater variety of defects can be found, thereby improving the determination of (non-)compliance.

In one embodiment the automated dispensing device comprises one or more sensors for providing feedback on the production process, wherein the one or more process values are indicative of feedback signals generated by the one or more sensors. The feedback signals can be fed forward to be used in the determination of (non-)compliance.

In another embodiment the further compliance inspection is performed by a human operator. The human operator can use the recommendation to selectively inspect only the medicament packages flagged for further compliance inspection.

In a further embodiment the method further comprises the steps of:
displaying the recommendation for further compliance inspection to the human operator; and
waiting for feedback on the further compliance inspection from the human operator.

A human operator assigned to inspection duties typically has great experience and dexterity in identifying defects which are hard to detect automatically and may decide reliably on the compliance of the flagged medicament packages.

In a further embodiment the method further comprises the step of:
displaying a reason for the recommendation together with the recommendation;
wherein the reason comprises one or more elements of information of the group comprising: the identified irregularity, a possible root cause associated with said irregularity and an inspection area containing said irregularity.

The reason for the recommendation may provide more context to enable the human operator to more reliably decide on the compliance of the flagged medicament packages. The reason may for example indicate the identified irregularity, the type of irregularity, the type of defect that may be caused by such irregularity, and/or an area to focus on, such as the information printed on the medicament package or the seal.

In an alternative embodiment of the method the further compliance inspection is at least partially automated. Hence, the amount of human labor involved with the further compliance inspection can be reduced.

In another embodiment the method further comprises the step of:
performing an automatic compliance check on the respective medicament package prior to recommending the further compliance inspection. The outcome of the automatic compliance check may be used to further assist the human operator in deciding on the compliance of the flagged medicament packages.

In a further embodiment the method further comprises the steps of:
recommending the at least one medicament package for a first type of the further compliance inspection when the outcome of the automatic compliance check is that the at least one respective medicament package is compliant; and
recommending the at least one medicament package for a second type of the further compliance inspection when the outcome of the automatic compliance check is that the at least one respective medicament package is non-compliant.

The identified irregularity in the process values does not always cause a defect in the medicament package large enough or serious enough to warrant discarding the respective medicament package. £ Hence, when an irregularity is identified, yet the automatic compliance check does not detect any defects, it is likely that many of the medicament packages are found to be compliant despite the identified irregularity. However, when the automatic compliance check confirms a non-compliance that is potentially caused by the identified irregularity, it is more likely that the respective medicament package is indeed non-compliant and will require appropriate correction, repair or should be discarded altogether. With the aforementioned distinction between the types of further compliance inspection, a type of further compliance inspection can be chosen which is most suited for the likelihood that the respective medicament package is indeed non-compliant. In particular, it can be prevented that time is wasted in one type of further compliance inspection while the other type of further compliance inspection is more suitable to handle the most likely outcome.

Alternatively, the method further comprises the steps of:
determining whether there is a relationship between the identified irregularity in the one or more process values and the outcome of the automatic compliance check;
recommending the at least one medicament package for a first type of the further compliance inspection when it is determined that there is no relationship between the identified irregularity in the one or more process values and the outcome of the automatic compliance check; and
recommending the at least one medicament package for a second type of the further compliance inspection when it is determined that there is relationship between the identified irregularity in the one or more process values and the outcome of the automatic compliance check.

This embodiment has the same technical advantages as the previously discussed embodiment. The distinction can however be made with more accuracy, because the medicament package is only recommended for the second type of the further compliance inspection when the identified irregularity and the outcome of the automatic compliance check are related, for example when an irregularity is detected in the process value of the sealing process corresponding to a non-compliance of the seal during the automatic compliance check.

In a further embodiment, the method further comprises the steps of:
providing an inspection station for compliance inspection and a correction station for compliance inspection and correction;
wherein the first type of further compliance inspection is carried out at the inspection station and the second type of further compliance inspection is carried out at the correction station.

The inspection station may conveniently be located in-line or in close proximity to the dispensing device to allow for a quick further compliance inspection with minimal impact on the further handling and/or processing of the medicament packages. In contrast, the correction station may be in a separate or dedicated location with more tools for a more thorough inspection and possible correction or repair. Medicament packages to be inspected in the correction station can be separated from the medicament packages which are found to be compliant and transferred from the inspection station to the correction station.

In a further embodiment the plurality of medicament packages are discharged from and collected outside of the automated dispensing device, wherein the automatic compliance check is performed outside of the automated dispensing device prior to or during collection of the plurality of medicament packages. Hence, the one or more process values from the production process inside the automated dispensing device may be combined with the outcome of the automatic compliance check outside of the automated dispensing device.

In another embodiment the method further comprises the steps of:
automatically flagging one or more medicament packages of the plurality of medicament packages for re-production. When it is determined with great certainty that the respective medicament package is non-compliant, the inspection step(s) can be skipped. In fact, the dispensing device may already be instructed to start re-producing the respective medicament package.

Preferably, the method further comprises the step of skipping at least a part of the production process for the one or more medicament packages which have been flagged for re-production. For example, when a printing error is detected upstream of the filling and/or sealing, the filling step or the sealing step may be skipped. Hence, the respective medicament package will arrive at the inspection station empty and/or unsealed. In this manner, the amount of waste as a result of incorrectly filled medicament packages can be reduced.

Additionally or alternatively, the method further comprises the step of:
recommending that the one or more medicament packages which have been flagged for re-production are removed without inspection. In this way, medicament packages which are certainly non-compliant do not have to be inspected, which can save valuable time.

In another embodiment the plurality of medicament packages forms a string. The order of the medicament packages within the string corresponds to the order in which the medicament packages were formed. Hence, the identified irregularity can be linked to a specific medicament package which can be traced to a position within the string based on the order in which it was produced. The string may be wound on a collection reel, for example a collection reel of a spooler, such that a large length of continuous string can be collected and stored for immediate inspection or inspection at a later stage.

In another embodiment the plurality of medicament packages are pouches. Said pouches are formed by dispensing discrete medicaments into a fold of a folded foil and by sealing the foil around the discrete medicaments to form individual closed pockets. Defects may occur in various steps of forming these pockets, in particular during the sealing. Such defects may be reflected by irregularities in the one or more process values.

In another embodiment the production process comprises one or more processes of the group comprising: storing of discrete medicaments, preparation of the discrete medicaments for dispensing, dispensing of the discrete medicaments, packaging of the discrete medicaments in the plurality of packages and discharging of said plurality of packages from the automated dispensing device. Any one of these processes may directly or indirectly cause defects in the discrete medicaments and/or the medicament packages.

In a further embodiment the process of dispensing comprises one or more of the following subprocesses: singulating the discrete medicaments prior to dispensing, dispensing of the discrete medicaments, intermediate collection of the dispensed discrete medicaments and discharging of the collected dispensed discrete medicaments.

In a further embodiment the process of packaging comprises one or more of the following subprocesses: feeding of packaging material used to form the medicament packages, printing of relevant information on the packaging material or the medicament packages, sealing the medicament packages, providing perforation lines and/or tear notches in or between the medicament packages and discharging the medicament packages from the automated dispensing device.

In another embodiment the one or more process values are indicative of one or more causes for non-compliance of the group comprising: a hardware issue, a software issue, incorrect storage of the discrete medicaments, incorrect filling of the discrete medicaments prior to dispensing, an overdispense, an underdispense, a failure to dispense, dispensing of an incorrect discrete medicament, dispensing of a damaged discrete medicament, an error in the collection of a dispensed discrete medicament, a failure to seal, a partial seal, a leaking seal, a perforation error, a tear notch error, a printing error, inferior printing quality, incorrectly printed information, incorrect handling of packaging material, incorrect packaging material, damaged packaging material, and an error during discharging of the medicament package.

According to a second aspect, the invention provides a system for determining compliance of a plurality of medicament packages for containing discrete medicaments dispensed and packaged by an automated dispensing device, wherein the system comprises a control unit that is configured for performing the steps of the method according to any one of the embodiments according to the first aspect of the invention.

The aforementioned system implements the steps of the method according to the first aspect and thus has the same technical advantages, which will not be repeated hereafter.

In a further embodiment the system further comprises a human machine interface that is operationally connected to the control unit, wherein the control unit is configured for causing the human machine interface to display the recommendation for further compliance inspection.

According to a third aspect, the invention provides an automated dispensing device comprising the system according to any one of the embodiments according to the second aspect of the invention.

The automated dispensing device, via the system, implements the steps of the method according to the first aspect of the invention and thus has the same technical advantages, which will not be repeated hereafter.

In a further embodiment, the automated dispensing device further comprises one or more sensors for providing feedback on the production process, wherein the control unit is operationally connected to said one or more sensors for receiving feedback signals generated by the one or more sensors, wherein the one or more process values are indicative of the feedback signals generated by the one or more sensors.

According to a fourth aspect, the invention provides a computer program product comprising a non-transitory computer-readable medium holding instructions that, when executed by a processor, cause the system according to any one of the embodiments according to the second aspect of the invention to perform the steps of the method according to any one of the embodiments according to the first aspect of the invention and therefore has the same technical advantages, which will not be repeated hereafter.

The various aspects and features described and shown in the specification can be applied, individually, wherever possible. These individual aspects, in particular the aspects and features described in the attached dependent claims, Can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a front view of an automated dispensing device for and a system for determining compliance of a plurality of medicament packages containing discrete medicaments dispensed and packaged by said automated dispensing device;

FIG. 2 shows a flow chart of a method for determining the compliance of the plurality of medicament packages with the use of the system according to FIG. 1;

FIG. 3 shows an alternative method for determining the compliance of the plurality of medicament packages with the use of the system according to FIG. 1; and

FIG. 4 shows an alternative method for flagging one or more medicament packages for re-production with the use of the system according to FIG. 1.

### DETAILED DESCRIPTION OF THE INVENTION

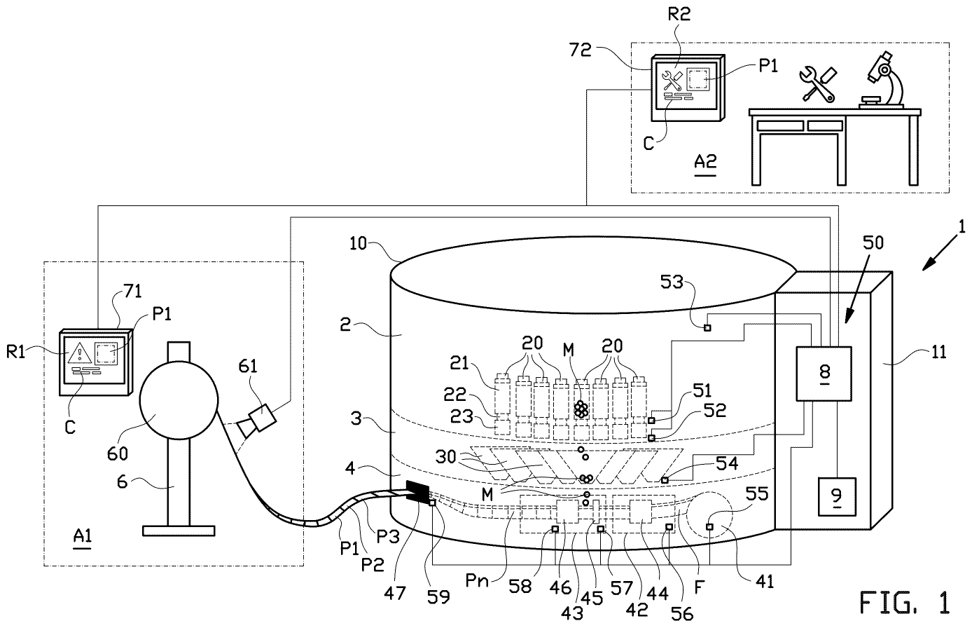

FIG. 1 shows an automatic or automated dispensing device 1 for dispensing and packing discrete medicaments M and a system 50 according to an exemplary embodiment of the invention for determining compliance of a plurality of medicament packages P1, P2, . . . , Pn which are intended for containing discrete medicaments M dispensed and packaged by said automated dispensing device 1. The system 50 may be part of the dispensing device 1 or share components with said dispensing device 1.

The discrete medicaments M can be discrete solid medicaments, pharmaceuticals or solid items, articles or substances for medical use, e.g. pills, tablets, capsules or the like. The medicaments are ‘discrete’ in the sense that they can be dispensed one-by-one, individually, separately or in dose units.

The dispensing device 1 comprises a housing 10 that defines a feeding section 2, a collection section 3 and a packaging section 4. The dispensing device 1 further comprises a control section 11 holding a control unit 8 and memory 9, for example a database, for controlling and monitoring the production process of the dispensing device 1.

The feeding section 2 accommodates a plurality of feeder units 20 held in a circular array of feeder positions, similar to the disclosure in US 2014/0366489 A1, the contents of which are incorporated herein by reference. Each feeder unit 20 comprises a container 21 for holding a stock of the discrete medicaments M, a dispensing mechanism 22 for singulating the discrete medicaments M and an outlet 23 for dispensing the singulated discrete medicaments M one-by-one. The collection section 3 comprises a plurality of collection trays 30 which are held in a circular array, again similar to US 2014/0366489 A1, for receiving the discrete medicaments M that are dispensed by the feeder units 2. The array of collection trays 30 is rotatable such that each collection tray 30 moves along all of the feeder positions.

The packaging section 4 is configured for receiving the discrete medicaments M collected in the collection section 3 and for packing or packaging said discrete medicaments M in the medicament packages P1-Pn. In this exemplary embodiment, the medicament packages P1-Pn are individually closed pockets or pouches formed in a continuous packaging material, in particular a foil F. More specifically, the packaging section 4 comprises a foil supply reel 41 for supplying the foil F, a printer unit 42 with a printer head 44 for printing relevant information, such as patient information or medical information, on the foil F and a sealing unit 43 with one or more sealing members 45, 46 for sealing the foil L around the discrete medicaments M. Typically, the foil F is pre-folded such that the discrete medicaments M can be received in the fold. The one or more sealing members 45, 46 subsequently seal the other three sides of the medicament package P1-Pn.

In this example, the collection section 3 is located below or vertical below the feeding section 2 and the packaging section 4 is located below or vertically below the collection section 3. The discrete medicaments M are dropped from one section 2, 3, 4 into the other under the influence of gravity.

The dispensing device 1 is further provided with a plurality of sensors 51-59 for monitoring the production process in the dispensing device 1. The production process comprises but is not limited to one or more processes of the group comprising: storing of discrete medicaments M, preparation of the discrete medicaments M for dispensing, dispensing of the discrete medicaments M, packaging of the discrete medicaments M in the plurality of packages P1-Pn and discharging of said plurality of packages P1-Pn from the dispensing device 1.

More in particular, the process of dispensing may include one or more of the following subprocesses: singulating the discrete medicaments M prior to dispensing, dispensing of the discrete medicaments M, intermediate collection of the dispensed discrete medicaments M and discharging of the collected dispensed discrete medicaments M.

Similarly, the process of packaging may include one or more of the following subprocesses: feeding of packaging material F used to form the medicament packages P1-Pn, printing of relevant information on the packaging material F or the medicament packages P1-Pn, sealing the medicament packages P1-Pn, providing perforation lines and/or tear notches in or between the medicament packages P1-Pn and discharging the medicament packages P1-Pn from the dispensing device 1.

In each of these processes, errors, faults or irregularities may occur that are outside of the ‘normal’ operation of the dispensing device 1. Each of these irregularities may cause defects in the discrete medicaments M and/or the medicament packages P1-Pn, such as an incorrect amount or type of discrete medicaments M, a damaged discrete medicament M, a partial seal, a leaking seal, a perforation error, a tear notch error, a printing error, inferior printing quality and/or incorrectly printed information. These defects may be a reason, depending on compliance requirements, to correct medicament packages P1-Pn which are found to be non-compliant or to discard such non-compliant medicament packages P1-Pn.

In this example, the plurality of sensors 51-59 comprises a first sensor 51 for monitoring singulation of the discrete medicaments M in the dispensing mechanism 22 of the feeder units 20, a second sensor 52 for monitoring the dispensing of the discrete medicaments M, in particular to detect an ‘overdispense’ when two or more discrete medicaments M are dispensed from the same feeder unit 20 at the same time, or an ‘underdispense’ when no discrete medicaments M are dispensed form a feeder unit 20 when the dispensing mechanism 22 is operated, a third sensor 53 for monitoring overall conditions in the dispensing device 1, such as storage conditions, a fourth sensor 54 to monitor the dispensing of the collected discrete medicaments M from the collection trays 30, a fifth sensor 55 for monitoring the supply of the packaging material, a sixth sensor 56 for monitoring the operation of the printer unit 42, a seventh sensor 57 and an eighth sensor 58 for monitoring to the operation of the packaging unit 43, in particular the operation of the one or more sealing members 45, 46, and a ninth sensor 59 for monitoring the discharge of the medicament packages P1-Pn from the dispensing device 1.

It will be apparent to one skilled in the art that more or a different selection of sensors 51-59 may be provided in the dispensing device 1 for monitoring relevant processes, subprocesses or operations related to the production process of the dispensing device 1.

The plurality of sensors 51-59 are configured for generating signals, in particular feedback signals, indicative of process values V1-Vn being monitored by said sensors 51-59. The process values V1-Vn are indicative process parameters in which errors, faults and/or irregularities may occur. In particular, the process values V1-Vn may relate to process parameters such as interruption of a light screen or a light beam, pressures, forces, currents, statuses and the like. The process values V1-Vn may be analog or digital. The control unit 8 is electronically, functionally and/or operationally connected to the plurality of sensors 51-59 for receiving said signals and for processing and/or analyzing the process values V1-Vn derivable from said signals. The process values V1-Vn are stored in the memory 9 together with the medicament packages P1-Pn and/or the medicaments M packed in said medicament packages P1-Pn that were produced using said process values V1-Vn.

As shown in FIG. 1, the packaging section 4 further comprises a discharge opening 47 in the housing 10 for discharging the medicament packages P1-Pn out of the dispensing device 1. In this example, the medicament packages P1-Pn are discharged from the dispensing device 1 in the form of a continuous string. Outside of the dispensing device 1, a spooler 6 is provided with a collection reel 60 for collecting the medicament packages P1-Pn over several windings of said string. At or near the spooler 6, a camera 61 may be provided to perform an automated or automatic compliance check. In this example, the camera 61 is a vision camera for obtaining scans or images of each medicament package P1-Pn. In this example, the control unit 8 is electronically, functionally and/or operationally connected to the camera 61 to receive the scans or images and to process and/or analyze said scans or images for compliance.

As shown in FIG. 1, an inspection station Al is provided at or near the spooler 6 for human or manual inspection of the medicament packages P1-Pn, e.g. inspection by a human operator, for example a pharmacist. Additionally, a correction station A2 may be provided which can also be used for inspection by a human operator, but which is further equipped for correction or repair of medicament packages P1-Pn which are found to be non-compliant. The correction station A2 may for example include a work-bench and tools for closer inspection, refilling and/or repacking. If the correction station A2 is provided, the inspection station Al is typically not used for correction or repair of the medicament packages P1-Pn. Alternatively, the correction station A2 may be provided with cameras, sensors and/or manipulators to at least partially automate the closer inspection, the correction and/or the repair of the medicament packages P1-Pn.

The system 50 further comprises one or more human machine interfaces 71, 72, for example screens or displays, to present information to the human operator(s) in the respective station(s) A1, A2. The one or more human machine interfaces 71, 72 are electronically, functionally and/or operationally connected to the control unit 8.

The control unit 8, the memory 9, the sensors 51-59, the camera 61 and/or the one or more human machine interfaces 71, 72 may be shared by both the dispensing device 1 and the system 50 for determining compliance of the plurality of medicament packages P1-Pn. Alternatively, one or more of the aforementioned components (or other additional components) may be provided as part of the system 50 separately from the dispensing device 1.

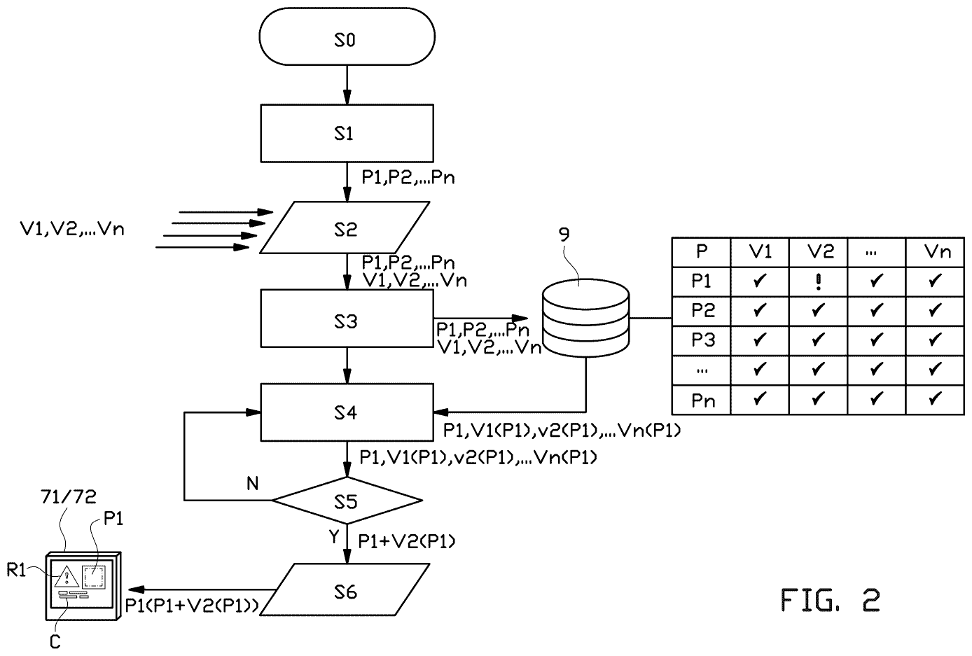

FIG. 2 shows the steps of a method for determining compliance of the plurality of medicament packages P1-Pn using the aforementioned system 50.

When the method is initiated (step S0), the dispensing device 1 is controlled or allowed to perform the production process (step S1). During the production process, the control unit 8 receives the signals from the sensors 51-59 in FIG. 1 indicative of the process values V1-Vn (step S2).

The control unit 8 is arranged, programmed or configured for associating the process values V1-Vn with the medicament packages P1-Pn which were produced with said process values V1-Vn (step S3). In other words: all process values V1-Vn representative of the conditions in the dispensing device 1 at the time of dispensing, packing or any other process or subprocess of the production process, ultimately resulting in discrete medicaments M being packed and discharged in a respective medicament package Pl are linked to the respective medicament package P1. The process values may for example be linked to a serial number of the respective medicament package P1, a patient number, a batch number or a recipe number related to the respective medicament package P1. The process values V1-Vn may be stored in the memory 9, for example in a database structure, cross-referenced with the information related to the medicament packages P1-Pn.

The control unit 8 is further arranged, programmed or configured for retrieving the process values V1-Vn for a respective one of the medicament packages P1-Pn, in this example P1, and analyzing said process values V1-Vn to identify any irregularities in the process values V1-Vn for the respective medicament package P1 (step S4). This analysis can include a comparison between the received process values V1-Vn for a respective one of the medicament packages P1-Pn and an expected process value which has been previously stored in the memory to find deviations from the expected values and identify these deviations as irregularities. In some cases, the expected values can be dynamic based on the most recent set of values received and/or compared to other recent values, and identify irregularities as anything outside an allowable deviation, for example, 10% of the average. The control unit 8 subsequently determines if one or more irregularities have been identified from the analysis for the respective medicament package P1 (step S5).

When no irregularities are identified, the process is repeated for any one of the subsequent medicament package P2-Pn, as reflected with the arrow ‘N’.

When one or more irregularities have been identified based on the analysis and comparison, for example as shown with exclamation mark “!” in the database table for process value V2 and medicament package P1, information about the respective medicament package P1, for example a serial number, a patient number, a batch number or a recipe number, is sent to one of the human machine interfaces 71, 72 together with a recommendation R1 for further compliance inspection for the respective medicament package P1 (step S6), causing the respective human machine interface 71, 72 to display said recommendation R1. The information sent to the one or more human machine interfaces 71, 72 may be accompanied by information indicative of the irregularity “!” and/or the process value V2, to provide a context or reason C for the recommendation R1.

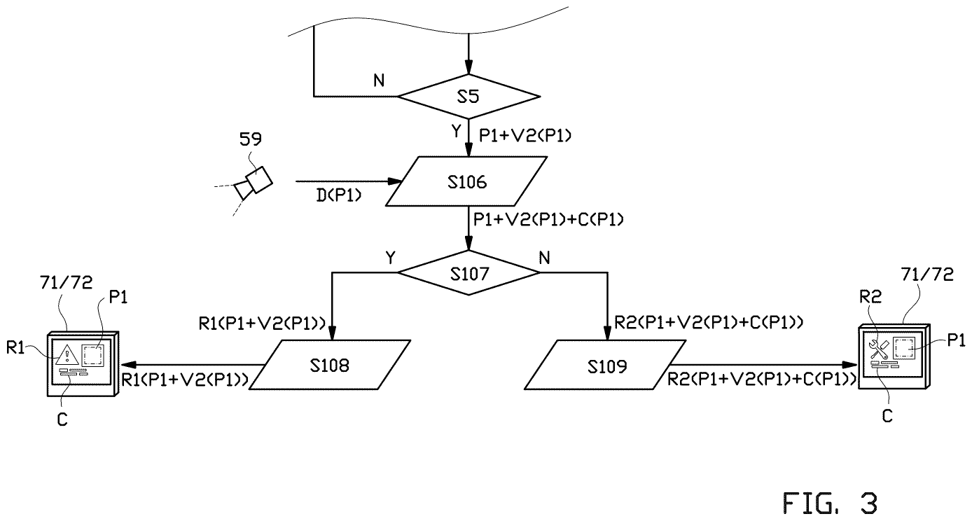

FIG. 3 shows an alternative step (step S106) following the step of determining if one or more irregularities have been identified for the respective medicament package P1 (step S5). In the alternative step (step S106) the scans or images from the camera 61 at the spooler 6 are processed to perform the automatic compliance check for the respective medicament package P1 and/or the outcome D of automatic compliance check based on said scans or images is received for the respective medicament package P1. The control unit is arranged, programmed or configured to determine whether the outcome of the automatic compliance check indicates that the respective medicament package is compliant or whether there is there a relationship between the identified irregularity in the one or more process values and the outcome of the automatic compliance check (step S107). The relationship may for example be determined based on a Ruleset or Artificial Intelligence that indicates possible relationships between the process values V1-Vn and possible outcomes of the automatic compliance check. The ruleset may for example indicate that there is relationship when the identified irregularity originates from a process value V1-Vn associated with the sealing of the respective medicament package P1 and the outcome D of the automatic compliance check is that the sealing of the respective medicament package P1 is non-compliant.

If the answer is ‘yes’, as reflected with arrow “Y”, a recommendation R1 is sent or issued to the one or more human machine interfaces 71, 72 for a first type of further compliance inspection to be carried out at the inspection station Al of FIG. 1 (step S108). If the answer is ‘no’, as reflected with arrow “N”, a different recommendation R2 is sent or issued to the one or more human machine interfaces 71, 72 for a second type of further compliance inspection to be carried out at the correction station A2 of FIG. 1 (step S109).

The recommendation R2 for the second type of further compliance inspection may be sent to the human machine interface 71 at the inspection station A1 and/or directly to the human machine interface 72 at the correction station A2. When the recommendation R2 for the second type of further compliance inspection is sent to the human machine interface 71 at the inspection station A1, the human operator at said inspection station A1 does not need to inspect the respective medicament package P1. Instead, the human operator may isolate or remove the respective medicament package P1 from the rest of the medicament packages P2-Pn, after which the respective medicament package P1 is transferred to the correction station A2 for the second type of further compliance inspection. Hence, no time is wasted on inspection of the respective medicament package P1 at the inspection station A1.

It is noted that the isolation and/or removal of the respective medicament package P1 from the rest of the medicament packages P2-Pn may alternatively be automated, for example with the use of an appropriately configured manipulator, such as a robot.

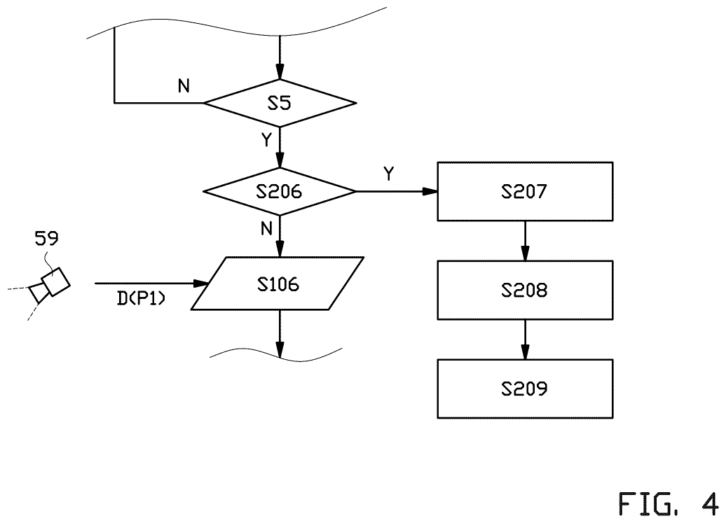

FIG. 4 shows that when an irregularity is detected early in the process with high certainty (step S206), for example at the printer unit 42, the control unit 8 may be arranged, programmed or configured to automatically flag the respective medicament package P1 for reproduction (step S207) and control the dispensing device 1 to skip any further steps of the production process related to the respective medicament package P1 (step S208).

For example, when the patient information is not printed at the correct location on the foil, the control unit 8 may already decide to discard the respective medicament package P1 and cancel the subsequent steps of filling and/or sealing the respective medicament package P1. Hence, the respective medicament package P1 will arrive at the inspection station Al empty and/or unsealed. In this manner, the amount of waste as a result of incorrectly filled medicament packages can be reduced.

The determination whether the respective medicament package P1 needs to be re-produced can be made independently of the human operator, for example with the help of a Rule Engine or Artificial Intelligence.

The control unit 8 may alert the human operator via the human machine interface 71 at the inspection station A1 to physically remove the faulty medicament package P1 from the string (step S209), or a robot may be provided to further automate the removal process.

The control unit 8 may be loaded with a computer program product, e.g. software, holding instructions that, when executed by a processor (part of the control unit 8), cause the system 50 to perform the aforementioned steps S1-S6, S106-S109 of the method. The computer program product may be stored on or comprise a non-transitory computer-readable medium, for example the memory 9 or a built-in memory of the control unit 8.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 dispensing device
10 housing
11 control section
2 feeding section
20 feeder unit
21 container
22 dispensing mechanism
23 outlet
3 collection section
30 collection tray
4 packaging section
41 foil supply reel
42 printer unit
43 packaging unit
44 printer head
45 first sealing member
46 second sealing member
47 discharge opening
50 system
51-59 sensors
6 spooler
60 collection reel
61 camera
71 first human machine interface
72 second human machine interface
8 control unit
9 memory
A1 inspection station
A2 correction station
C reason
D outcome of automatic compliance check
F foil
M medicament
P1-Pn medicament packages
R1 recommendation for a first type of further compliance inspection
R2 recommendation for a second type of further compliance inspection
SO method
S1 step S1: “perform production process”
S2 step S2: “receive process values”
S3 step S3: “associate process values with the medicament packages”
S4 steps S4: “identify irregularities in the process values for a respective medicament package”
S5 step S5: “one or more irregularities identified?”
S6 step S6: “issue recommendation for further compliance inspection for the respective medicament package”
S106 step S106: “receive outcome of automatic compliance check for the respective medicament package”
S107 step S107: “does the outcome of the automatic compliance check indicate that the respective medicament package is compliant? is there a relationship between the identified irregularity in the one or more process values and the outcome of the automatic compliance check?”
S108 step S108: “issue recommendation for a first type of further compliance inspection for the respective medicament package to be carried out at the inspection station”
S109 step S109: “issue recommendation for a second type of further compliance inspection for the respective medicament package to be carried out at the correction station”
S206 step S206: “respective medicament package non-compliant with high certainty?”
S207 step S207: “automatically flag one or more medicament packages for re-production”
S208 step S208: “skip at least a part of the production process for the one or more medicament packages which have been flagged for re-production”
S209 step S209: “issue a recommendation that the one or more medicament packages which have been flagged for re-production are removed without inspection”
V1-Vn process values ! irregularity

1.-25. (canceled).

26. Method for determining compliance of a plurality of medicament packages for containing discrete medicaments dispensed and packaged by an automated dispensing device comprising a control unit and one or more sensors for providing feedback on a production process, wherein the method comprises the steps of:
for each medicament package of the plurality of medicament packages (P1-Pn), associating with the respective medicament package one or more process values indicative of the production process of the automated dispensing device affecting at least one of the respective medicament packages or the discrete medicaments contained in said respective medicament package, wherein the one or more process values are indicative of feedback signals generated by the one or more sensors;
comparing the process values for a respective one of the medicament packages P1-Pn and an expected process value which has been previously stored in a memory to find deviations from the expected values;
identifying the deviations as irregularities in the one or more process values;
recommending at least one medicament package of the plurality of medicament packages for further compliance inspection based on an identified irregularity in the one or more process values associated with said at least one medicament package;
performing an automatic compliance check on the respective medicament package prior to recommending the further compliance inspection;
recommending the at least one medicament package for a first type of the further compliance inspection when the outcome of the automatic compliance check is that the at least one respective medicament package is compliant; and
recommending the at least one medicament package for a second type of the further compliance inspection when the outcome of the automatic compliance check is that the at least one respective medicament package is non-compliant.

27. The method according to claim 26, wherein the further compliance inspection is performed by a human operator.

28. The method according to claim 27, wherein the method further comprises the steps of:
displaying the recommendation for further compliance inspection to the human operator; and
waiting for feedback on the further compliance inspection from the human operator.

29. The method according to claim 28, wherein the method further comprises the step of:
displaying a reason for the recommendation together with the recommendation;
wherein the reason comprises one or more elements of information of the group comprising: the identified irregularity, a possible root cause associated with said irregularity and an inspection area containing said irregularity.

30. The method according to claim 26, wherein the further compliance inspection is at least partially automated.

31. The method according to claim 26, wherein the method further comprises the steps of:
providing an inspection station for compliance inspection and a correction station for compliance inspection and correction;
wherein the first type of further compliance inspection is carried out at the inspection station and the second type of further compliance inspection is carried out at the correction station.

32. Method according to claim 26, wherein the plurality of medicament packages are discharged from and collected outside of the automated dispensing device, wherein the automatic compliance check is performed outside of the automated dispensing device prior to or during collection of the plurality of medicament packages.

33. The method according to claim 26, wherein the method further comprises the steps of:
automatically flagging one or more medicament packages of the plurality of medicament packages for re-production.

34. The method according to claim 33, wherein the method further comprises the step of skipping at least a part of the production process for the one or more medicament packages which have been flagged for re-production.

35. The method according to claim 33, wherein the method further comprises the step of:
recommending that the one or more medicament packages which have been flagged for re-production are removed without inspection.

36. The method according to claim 26, wherein the plurality of medicament packages forms a string.

37. The method according to claim 26, wherein the plurality of medicament packages are pouches.

38. The method according to claim 26, wherein the production process comprises one or more processes of the group comprising: storing of discrete medicaments, preparation of the discrete medicaments for dispensing, dispensing of the discrete medicaments, packaging of the discrete medicaments in the plurality of packages and discharging of said plurality of packages from the automated dispensing device.

39. The method according to claim 38, wherein the process of dispensing comprises one or more of the following subprocesses: singulating the discrete medicaments prior to dispensing, dispensing of the discrete medicaments, intermediate collection of the dispensed discrete medicaments and discharging of the collected dispensed discrete medicaments.

40. The method according to claim 38, wherein the process of packaging comprises one or more of the following subprocesses: feeding of packaging material used to form the medicament packages, printing of relevant information on the packaging material or the medicament packages, sealing the medicament packages, providing perforation lines and/or tear notches in or between the medicament packages and discharging the medicament packages from the automated dispensing device.

41. The method according to claim 26, wherein the one or more process values are indicative of one or more causes for non-compliance of the group comprising: a hardware issue, a software issue, incorrect storage of the discrete medicaments, incorrect filling of the discrete medicaments prior to dispensing, an overdispense, an underdispense, a failure to dispense, dispensing of an incorrect discrete medicament, dispensing of a damaged discrete medicament, an error in the collection of a dispensed discrete medicament, a failure to seal, a partial seal, a leaking seal, a perforation error, a tear notch error, a printing error, inferior printing quality, incorrectly printed information, incorrect handling of packaging material, incorrect packaging material, damaged packaging material, and an error during discharging of the medicament package.

42. An automated dispensing device for dispensing and packaging discrete medicaments into a plurality of medicament packages, the automated dispensing device comprising a system for determining compliance of a plurality of medicament packages containing discrete medicaments dispensed and packaged by the automated dispensing device, wherein the device further comprises one or more sensors for providing feedback on the production process; and a control unit that is configured to perform the steps of the method according to claim 26.

43. The automated dispensing device according to claim 42, wherein the system further comprises a human machine interface that is operationally connected to the control unit, wherein the control unit is configured for causing the human machine interface to display the recommendation for further compliance inspection.

44. The automated dispensing device according to claim 42, wherein the control unit is operationally connected to said one or more sensors for receiving feedback signals generated by the one or more sensors, wherein the one or more process values are indicative of the feedback signals generated by the one or more sensors.

45. A computer program product comprising a non-transitory computer-readable medium holding instructions that, when executed by a processor, cause an automated dispensing device to perform the steps of the method according to claim 26.
